(19) United States
(12) Patent Application Publication
(10) Pub. No.: US 2025/0208250 A1
(43) Pub. Date: Jun. 26, 2025

(54) ADAPTATION OF INDOOR LOCALIZATION SYSTEM

(71) Applicant: Intel Corporation, Santa Clara, CA (US)

(72) Inventors: Kedar Viswanathan, Bengaluru (IN); Vaibhav Singh, New Delhi (IN)

(21) Appl. No.: 19/080,538

(22) Filed: Mar. 14, 2025

(51) Int. Cl. G01S 5/02; H04W 24/10; H04W 48/16

(52) U.S. Cl. CPC G01S 5/0252; H04W 24/10; H04W 48/16

(57) ABSTRACT

A fingerprint is received from a device that identifies a plurality of signal strength values corresponding to a plurality of wireless access points as measured by the device within a physical environment. A first machine learning model is used to determine that a subset of access points in the plurality of wireless access points are missing in the physical environment based on the fingerprint, and a machine-learning-based localization model is modified to generate a modified localization model to account for the subset of access points missing in the physical environment, where the localization model is trained based on training data collected when the plurality of wireless access points were present and operational within the environment.

### BACKGROUND

Edge computing, including mobile edge computing, may offer application developers and content providers cloud-computing capabilities and an information technology service environment at the edge of a network. Edge computing may have some advantages when compared to traditional centralized cloud computing environments. For example, edge computing may provide a service to a user equipment (UE) with a lower latency, a lower cost, a higher bandwidth, a closer proximity, or an exposure to real-time radio network and context information.

Edge computing may, in some scenarios, offer or host a cloud-like distributed service, to offer orchestration and management for applications, coordinated service instances and machine learning, such as federated machine learning, among many types of storage and compute resources. Edge computing is also expected to be closely integrated with existing use cases and technology developed for IoT and Fog/distributed networking configurations, as endpoint devices, clients, and gateways attempt to access network resources and applications at locations closer to the edge of the network.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 illustrates an overview of an Edge cloud configuration for edge computing.

FIG. 2 illustrates operational layers among endpoints, an edge cloud, and cloud computing environments.

FIG. 3 illustrates an example approach for networking and services in an edge computing system.

FIG. 4 illustrates a block diagram for an example edge computing device.

FIG. 5 illustrates an overview of layers of distributed compute deployed among an edge computing system.

FIG. 6 is a simplified block diagram illustrating the use of an example localization model.

FIG. 7 is a simplified block diagram illustrating an example physical environment and the collection of wireless signal strength values at coordinates within the environment.

FIG. 8 is a simplified block diagram illustrating an example indoor localization system.

FIG. 9 is a simplified block diagram illustrating interactions between an example indoor localization system and an example wireless network infrastructure.

FIGS. 10A-10B are simplified block diagrams of an example model for detecting missing wireless access points in an environment.

FIG. 11 is a simplified flow diagram showing an example use of a model for detecting missing wireless access points in an environment.

FIG. 12 is a simplified block diagram illustrating example modification of an indoor localization model.

FIG. 13 is a simplified flow diagram of an example system to test an example indoor localization system.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

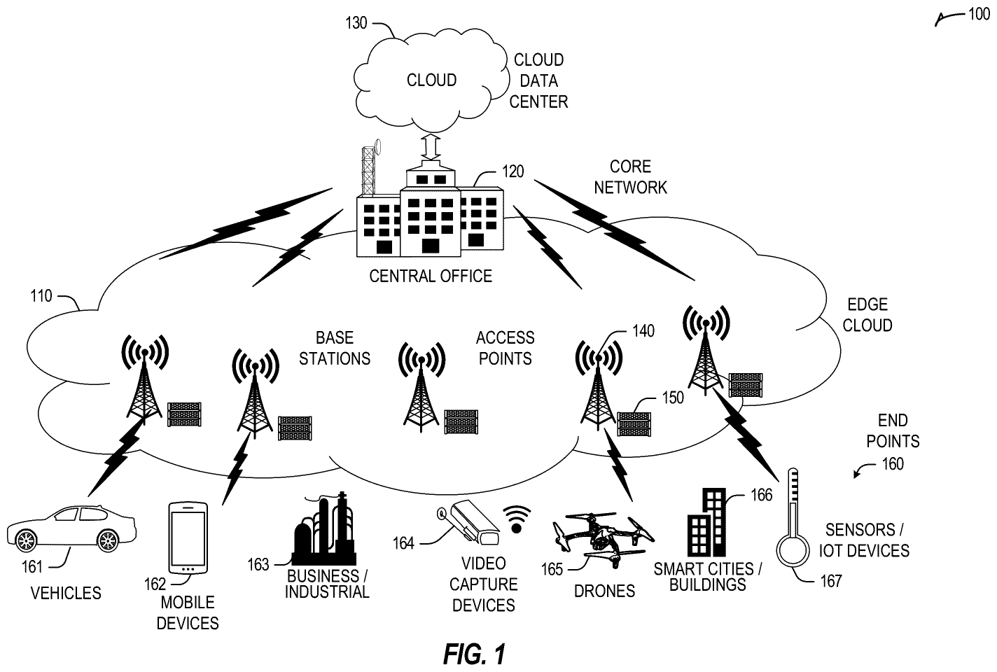

FIG. 1 is a block diagram 100 showing an overview of a configuration for edge computing, which includes a layer of processing referred to in many of the following examples as an “edge cloud” or “edge system”. As shown, the edge cloud 110 is co-located at an edge location, such as an access point or base station 140, a local processing hub 150, or a central office 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the edge cloud 110 may be leveraged to provide ultra-low latency response times for services and functions used by the endpoint data sources 160 as well as reduce network backhaul traffic from the edge cloud 110 toward cloud data center 130 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the resources needed for network services, through the distribution of more resources which are located closer both geographically and in network access time. In this manner, edge computing attempts to bring the compute resources to the workload data where appropriate, or bring the workload data to the compute resources.

Edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services where the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

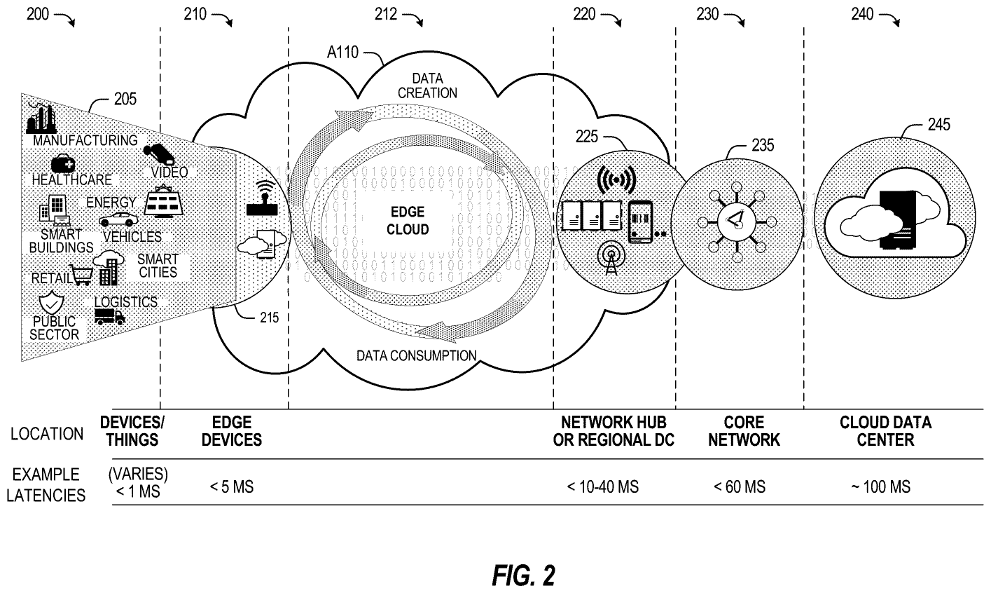

FIG. 2 illustrates operational layers among endpoints, an edge cloud, and cloud computing environments. Specifically, FIG. 2 depicts examples of computational use cases 205, utilizing the edge cloud 110 among multiple illustrative layers of network computing. The layers begin at an endpoint (devices and things) layer 200, which accesses the edge cloud 110 to conduct data creation, analysis, and data consumption activities. The edge cloud 110 may span multiple network layers, such as an edge devices layer 210 having gateways, on-premise servers, or network equipment (nodes 215) located in physically proximate edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the edge cloud 110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 200, under 5 ms at the edge devices layer 210, to even between 10 to 40 ms when communicating with nodes at the network access layer 220. Beyond the edge cloud 110 are core network 230 and cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 235 or a cloud data center 245, a central office or content data network may be considered as being located within a “near edge” layer (“near” to the cloud, having high latency values when communicating with the devices and endpoints of the use cases 205), whereas an access point, base station, on-premise server, or network gateway may be considered as located within a “far edge” layer (“far” from the cloud, having low latency values when communicating with the devices and endpoints of the use cases 205). It will be understood that other categorizations of a particular network layer as constituting a “close”, “local”, “near”, “middle”, or “far” edge may be based on latency, distance, number of network hops, or other measurable characteristics, as measured from a source in any of the network layers 200-240.

The various use cases 205 may access resources under usage pressure from incoming streams, due to multiple services utilizing the edge cloud. To achieve results with low latency, the services executed within the edge cloud 110 balance varying requirements in terms of: (a) Priority (throughput or latency) and Quality of Service (QOS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor, etc.).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to Service Level Agreement (SLA), the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (e.g., Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following traditional caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required because edge locations may be unmanned and may even need permissioned access (e.g., when housed in a third-party location). Such issues may be magnified in the edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 110 (network layers 200-240), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 110.

As such, the edge cloud 110 is formed from network components and functional features operated by and within edge gateway nodes, edge aggregation nodes, or other edge compute nodes among network layers 210-230. The edge cloud 110 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 110 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks, etc.) may also be utilized in place of or in combination with such 3GPP carrier networks.

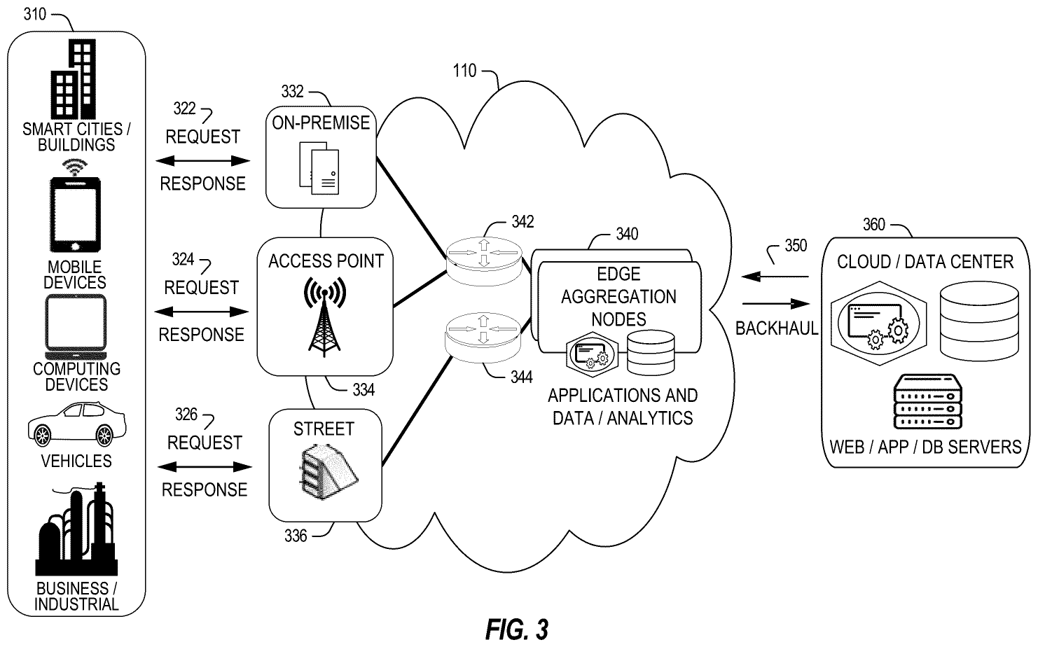

In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., a cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 110 to aggregate traffic and requests. Thus, within the edge cloud 110, the TSP may deploy various compute and storage resources, such as at edge aggregation nodes 340, to provide requested content. The edge aggregation nodes 340 and other systems of the edge cloud 110 are connected to a cloud or data center 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 110 or other areas of the TSP infrastructure.

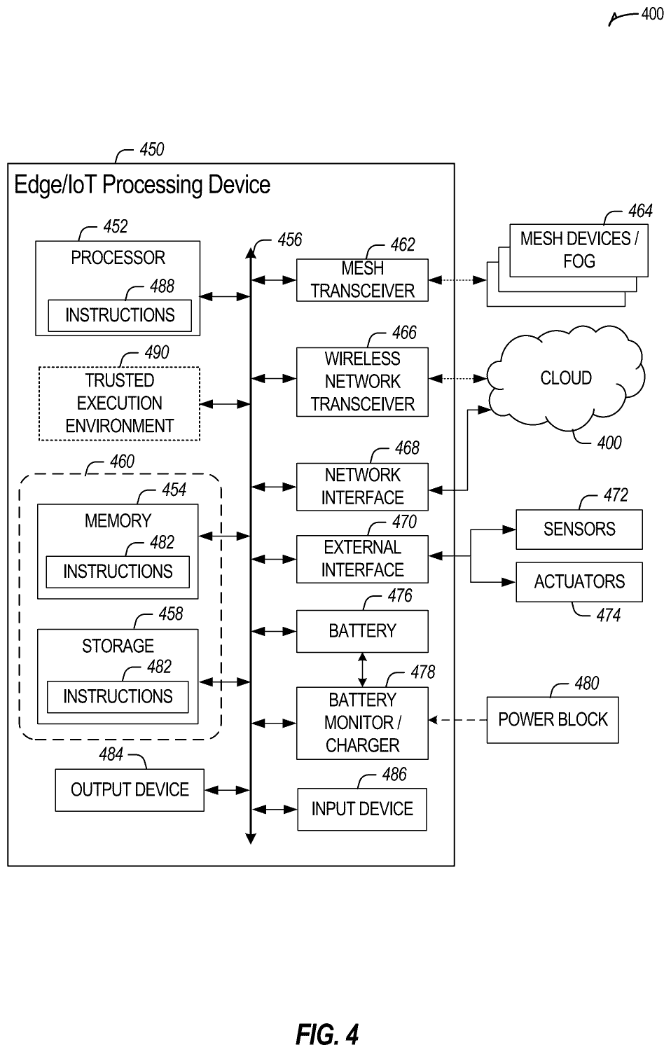

FIG. 4 is a block diagram of an example of components that may be present in an example edge computing device 450 for implementing the techniques described herein. The edge device 450 may include any combinations of the components shown in the example or referenced in the disclosure above. The components may be implemented as ICs, intellectual property blocks, portions thereof, discrete electronic devices, or other modules, logic, hardware, software, firmware, or a combination thereof adapted in the edge device 450, or as components otherwise incorporated within a chassis of a larger system. Additionally, the block diagram of FIG. 4 is intended to depict a high-level view of components of the edge device 450. However, some of the components shown may be omitted, additional components may be present, and different arrangement of the components shown may occur in other implementations.

The edge device 450 may include processor circuitry in the form of, for example, a processor 452, which may be a microprocessor, a multi-core processor, a multithreaded processor, an ultra-low voltage processor, an embedded processor, or other known processing elements. The processor 452 may be a part of a system on a chip (SoC) in which the processor 452 and other components are formed into a single integrated circuit, or a single package. The processor 452 may communicate with a system memory 454 over an interconnect 456 (e.g., a bus). Any number of memory devices may be used to provide a given amount of system memory. To provide for persistent storage of information such as data, applications, operating systems and so forth, a storage 458 may also couple to the processor 452 via the interconnect 456. In an example the storage 458 may be implemented via a solid state disk drive (SSDD). Other devices that may be used for the storage 458 include flash memory cards, such as SD cards, microSD cards, xD picture cards, and the like, and USB flash drives. In low power implementations, the storage 458 may be on-die memory or registers associated with the processor 452. However, in some examples, the storage 458 may be implemented using a micro hard disk drive (HDD). Further, any number of new technologies may be used for the storage 458 in addition to, or instead of, the technologies described, such resistance change memories, phase change memories, holographic memories, or chemical memories, among others.

The components may communicate over the interconnect 456. The interconnect 456 may include any number of technologies, including industry standard architecture (ISA), extended ISA (EISA), peripheral component interconnect (PCI), peripheral component interconnect extended (PCIx), PCI express (PCIe), or any number of other technologies. The interconnect 456 may be a proprietary bus, for example, used in a SoC based system. Other bus systems may be included, such as an 12C interface, an SPI interface, point to point interfaces, and a power bus, among others.

Given the variety of types of applicable communications from the device to another component or network, applicable communications circuitry used by the device may include or be embodied by any one or more of components 462, 466, 468, or 470. Accordingly, in various examples, applicable means for communicating (e.g., receiving, transmitting, etc.) may be embodied by such communications circuitry. For instance, the interconnect 456 may couple the processor 452 to a mesh transceiver 462, for communications with other mesh devices 464. The mesh transceiver 462 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. The mesh transceiver 462 may communicate using multiple standards or radios for communications at different ranges.

A wireless network transceiver 466 may be included to communicate with devices or services in the cloud 400 via local or wide area network protocols. For instance, the edge device 450 may communicate over a wide area using LoRaWAN™ (Long Range Wide Area Network), among other example technologies. Indeed, any number of other radio communications and protocols may be used in addition to the systems mentioned for the mesh transceiver 462 and wireless network transceiver 466, as described herein. For example, the radio transceivers 462 and 466 may include an LTE or other cellular transceiver that uses spread spectrum (SPA/SAS) communications for implementing high speed communications. Further, any number of other protocols may be used, such as Wi-Fi® networks for medium speed communications and provision of network communications. A network interface controller (NIC) 468 may be included to provide a wired communication to the cloud 400 or to other devices, such as the mesh devices 464. The wired communication may provide an Ethernet connection, or may be based on other types of networks, protocols, and technologies.

The interconnect 456 may couple the processor 452 to an external interface 470 that is used to connect external devices or subsystems. The external devices may include sensors 472, such as accelerometers, level sensors, flow sensors, optical light sensors, camera sensors, temperature sensors, a global positioning system (GPS) sensor, pressure sensors, barometric pressure sensors, and the like. The external interface 470 further may be used to connect the edge device 450 to actuators 474, such as power switches, valve actuators, an audible sound generator, a visual warning device, and the like.

In some optional examples, various input/output (I/O) devices may be present within, or connected to, the edge device 450. Further, some edge computing devices may be battery powered and include one or more batteries (e.g., 476) to power the device. In such instances, a battery monitor/charger 478 may be included in the edge device 450 to track the state of charge (SoCh) of the battery 476. The battery monitor/charger 478 may be used to monitor other parameters of the battery 476 to provide failure predictions, such as the state of health (SoH) and the state of function (SoF) of the battery 476, which may trigger an edge system to attempt to provision other hardware (e.g., in the edge cloud or a nearby cloud system) to supplement or replace a device whose power is failing, among other example uses. In some instances, the device 450 may also or instead include a power block 480, or other power supply coupled to a grid, may be coupled with the battery monitor/charger 478 to charge the battery 476. In some examples, the power block 480 may be replaced with a wireless power receiver to obtain the power wirelessly, for example, through a loop antenna in the edge device 450, among other examples.

The storage 458 may include instructions 482 in the form of software, firmware, or hardware commands to implement the workflows, services, microservices, or applications to be carried out in transactions of an edge system, including techniques described herein. Although such instructions 482 are shown as code blocks included in the memory 454 and the storage 458, it may be understood that any of the code blocks may be replaced with hardwired circuits, for example, built into an application specific integrated circuit (ASIC). In some implementations, hardware of the edge computing device 450 (separately, or in combination with the instructions 488) may configure execution or operation of a trusted execution environment (TEE) 490. In an example, the TEE 490 operates as a protected area accessible to the processor 452 for secure execution of instructions and secure access to data, among other example features.

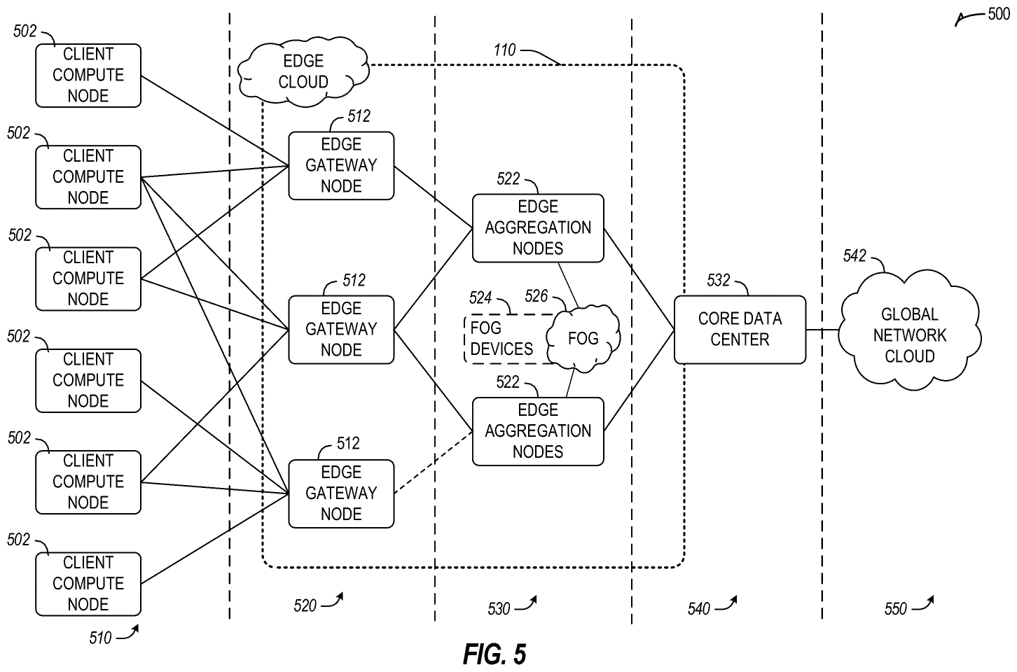

At a more generic level, an edge computing system may be described to encompass any number of deployments operating in an edge cloud 110, which provide coordination from client and distributed computing devices. FIG. 5 provides a further abstracted overview of layers of distributed compute deployed among an edge computing environment for purposes of illustration. For instance, FIG. 5 generically depicts an edge computing system for providing edge services and applications to multi-stakeholder entities, as distributed among one or more client compute nodes 502, one or more edge gateway nodes 512, one or more edge aggregation nodes 522, one or more core data centers 532, and a global network cloud 542, as distributed across layers of the network. The implementation of the edge computing system may be provided at or on behalf of a telecommunication service provider (“telco”, or “TSP”), internet-of-things service provider, cloud service provider (CSP), enterprise entity, or any other number of entities.

Each node or device of the edge computing system is located at a particular layer corresponding to layers 510, 520, 530, 540, 550. For example, the client compute nodes 502 are each located at an endpoint layer 510, while each of the edge gateway nodes 512 are located at an edge devices layer 520 (local level) of the edge computing system. Additionally, each of the edge aggregation nodes 522 (and/or fog devices 524, if arranged or operated with or among a fog networking configuration 526) are located at a network access layer 530 (an intermediate level). Fog computing (or “fogging”) generally refers to extensions of cloud computing to the edge of an enterprise's network, typically in a coordinated distributed or multi-node network. Some forms of fog computing provide the deployment of compute, storage, and networking services between end devices and cloud computing data centers, on behalf of the cloud computing locations. Such forms of fog computing provide operations that are consistent with edge computing as discussed herein; many of the edge computing aspects discussed herein are applicable to fog networks, fogging, and fog configurations. Further, aspects of the edge computing systems discussed herein may be configured as a fog, or aspects of a fog may be integrated into an edge computing architecture.

The core data center 532 is located at a core network layer 540 (e.g., a regional or geographically-central level), while the global network cloud 542 is located at a cloud data center layer 550 (e.g., a national or global layer). The use of “core” is provided as a term for a centralized network location—deeper in the network—which is accessible by multiple edge nodes or components; however, a “core” does not necessarily designate the “center” or the deepest location of the network. Accordingly, the core data center 532 may be located within, at, or near the edge cloud 110.

Although an illustrative number of client compute nodes 502, edge gateway nodes 512, edge aggregation nodes 522, core data centers 532, global network clouds 542 are shown in FIG. 5, it should be appreciated that the edge computing system may include more or fewer devices or systems at each layer. Additionally, as shown in FIG. 5, the number of components of each layer 510, 520, 530, 540, 550 generally increases at each lower level (i.e., when moving closer to endpoints). As such, one edge gateway node 512 may service multiple client compute nodes 502, and one edge aggregation node 522 may service multiple edge gateway nodes 512.

Consistent with the examples provided herein, each client compute node 502 may be embodied as any type of end point component, device, appliance, or “thing” capable of communicating as a producer or consumer of data. Further, the label “node” or “device” as used in the edge computing system 500. As such, the edge cloud 110 is formed from network components and functional features operated by and within the edge gateway nodes 512 and the edge aggregation nodes 522 of layers 520, 530, respectively. The edge cloud 110 may be embodied as any type of network that provides edge computing and/or storage resources which are proximately located to radio access network (RAN) capable endpoint devices (e.g., mobile computing devices, IoT devices, smart devices, etc.), which are shown in FIG. 5 as the client compute nodes 502. In other words, the edge cloud 110 may be envisioned as an “edge” which connects the endpoint devices and traditional mobile network access points that serves as an ingress point into service provider core networks, including carrier networks (e.g., Global System for Mobile Communications (GSM) networks, Long-Term Evolution (LTE) networks, 5G networks, etc.), while also providing storage and/or compute capabilities. Other types and forms of network access (e.g., Wi-Fi, long-range wireless networks) may also be utilized in place of or in combination with such 3GPP carrier networks.

In some examples, the edge cloud 110 may form a portion of or otherwise provide an ingress point into or across a fog networking configuration 526 (e.g., a network of fog devices 524, not shown in detail), which may be embodied as a system-level horizontal and distributed architecture that distributes resources and services to perform a specific function. For instance, a coordinated and distributed network of fog devices 524 may perform computing, storage, control, or networking aspects in the context of an IoT system arrangement. Other networked, aggregated, and distributed functions may exist in the edge cloud 110 between the cloud data center layer 550 and the client endpoints (e.g., client compute nodes 502).

The edge gateway nodes 512 and the edge aggregation nodes 522 cooperate to provide various edge services and security to the client compute nodes 502. Furthermore, because each client compute node 502 may be stationary or mobile, each edge gateway node 512 may cooperate with other edge gateway devices to propagate presently provided edge services and security as the corresponding client compute node 502 moves about a region. To do so, each of the edge gateway nodes 512 and/or edge aggregation nodes 522 may support multiple tenancy and multiple stakeholder configurations, in which services from (or hosted for) multiple service providers and multiple consumers may be supported and coordinated across a single or multiple compute devices.

Edge computing systems, such as introduced above, may be utilized to provide hardware and logic to implement various applications and services, including machine learning and artificial intelligence applications. The development and application of artificial intelligence (AI)- and machine learning-based solutions are growing at an unprecedented rate. From generative AI solutions (e.g., large language models, ChatGPT™, chat bots, Bard, Gemini, Grok, etc.) to self-driving cars and robotics, AI is becoming pervasive. The algorithms and models that drive AI and machine learning solutions generally rely on extensive training using large and, in some cases, continuously evolving data sets so as to acquire the “intelligence” that makes these solutions so useful. Edge computing device may additionally be used to execute portions (or all) of an indoor localization system, such as discussed herein. In some implementations, an indoor localization system, including the machine-learning-based models (and the training and retraining of these models) may be implemented in a distributed manner across multiple edge devices, utilizing their combined compute and/or memory resources, among other example implementations.

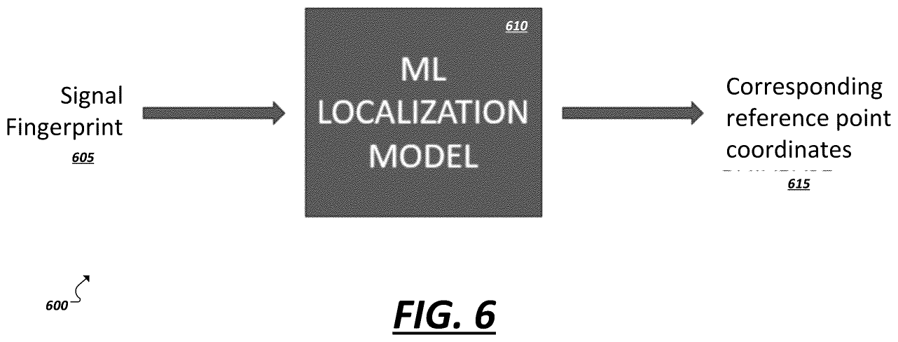

A variety of techniques may be utilized to locate a given device, including endpoint devices, edge devices, fog deices, etc., including Global Positioning System (GPS), cell tower triangulation, Wi-Fi Positioning System (WPD), Bluetooth beacons, and other techniques. Fingerprinting-based localization is another technique for performing localization utilizing radio signal “fingerprints” (FPs) detected by a device within an environment and inferring the location of the device based on the FP (e.g., by providing the FP as an input to a machine learning (ML) model trained for the environment). Fingerprinting-based localization can better capture the received signal strength (RSS) variability in the environment caused by scattering/fading. An offline “fingerprinting phase” may be performed for a physical environment of interest by collecting radio signal fingerprints at various reference points (RPs) within the environment (e.g., at equidistant points on a grid within the physical environment or other points within the environment). FIG. 6 is a simplified block diagram 600 showing an example fingerprinting-based localization, where fingerprint data 605 collected by a device (e.g., from the signal strengths measured by the device from multiple radio transmitters when the device is at a certain position within the environment) is fed as an input to machine-learning-based localization model 610 trained to infer the location 615 of the device (e.g., relative to various reference points within the environment) based on the fingerprint data 605.

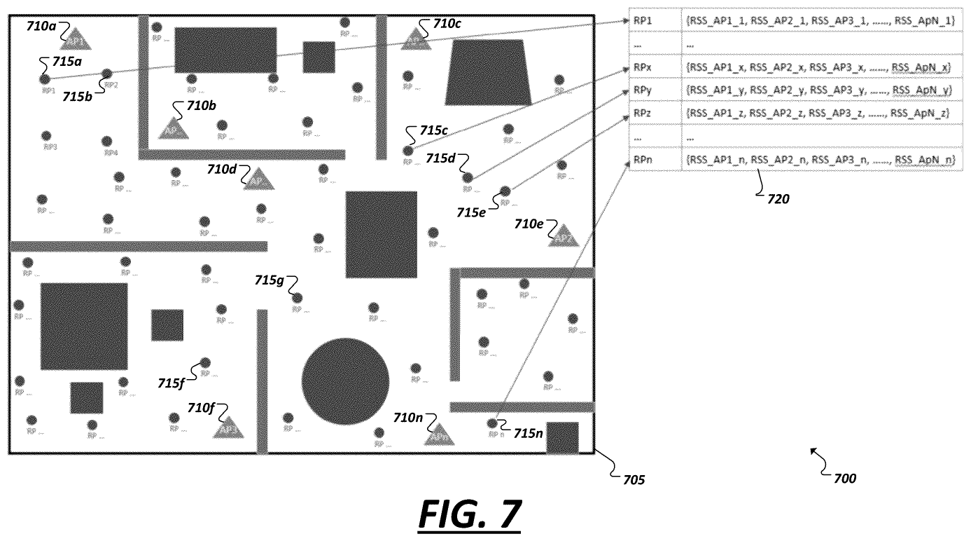

Turning to FIG. 7, a diagram 700 is shown of an example physical environment 705 including a number N access points (APs) (e.g., 710a-n), such as Wi-Fi access points, and a number n physical reference point locations (RPs) (e.g., 715a-n) within the environment 705. The environment (e.g., an office building, a warehouse, manufacturing plant, etc.) may include a variety of physical objects and impediments to signal propagation within the space (e.g., walls, machinery, furniture, electronics, etc.), such that a device (e.g., a user endpoint, edge computing device, etc.) within the environment receives signals from combination of the APs 710a-n non-uniformly within the environment. Similarly, at various reference points 715a-n within the environment, signal strengths from the APs 710a-n may be experienced and measured and recorded (at 720). The collective signal strengths measured for each of the APs 710a-n at a given RP (e.g., reference point RP1 715a) may be recorded as a fingerprint (e.g., 725) represented as a vector of RSS measurements from all APs detected at the RP (e.g., 715a). The collection of training fingerprints (e.g., 720) may be used to train machine learning localization models in a supervised manner to predict the physical location of a device given an input radio fingerprint collected by the device. The localization model learns to map RSS FPs to their corresponding physical locations (e.g., RP co-ordinates). The trained model is then deployed for indoor localization of real-time fingerprints.

In one example, a localization model may be based, mathematically, as a function LM ( ) reflected by Equation 1 (representing a location prediction by the localization model):

$$\{ {x}_{{pred}_{i}} , {y}_{{pred}_{i}} , {floor}_{{pred}_{i}} \} = LM ( {FP}_{i} )$$

where, {x_{pred}_{ᵢ}, y_{pred}_{ᵢ}, floor_{pred}_{ᵢ}}=predicted location for validation FPᵢ, and FPᵢ={RSS_{AP1}_{ᵢ}, RSS_{AP2}_{ᵢ}, . . . , . . . , . . . , RSS_{APN}_{ᵢ}}, where N=Number of active APs in the system. The localization performance may be monitored using two metrics, including building and floor classification rate, as shown below in Equation 2:

$$Success Rate = \frac{\# of Online FPs classified to correct building and floor}{Total \# of Online FPs processed} \times 100$$

and, the average localization error (e.g., a calculation of the Euclidean distance between predicted and actual locations), as shown below in Equation 3:

$$Avg Loc Error = \frac{1}{{O}_{c}} {\sum }_{i = 1}^{{V}_{c}} \sqrt{{( {x}_{{pred}_{i}} - {x}_{{act}_{i}} )}^{2} + {( {y}_{{pred}_{i}} - {y}_{{act}_{i}} )}^{2}}$$

where, {x_{pred}_{ᵢ}, y_{pred}_{ᵢ}, floor_{pred}_{ᵢ}}=actual location of validation FPᵢ, O_{c}=number of online FPS till now classified to the correct building and floor.

Fingerprinting-based indoor localization, while a valuable localization approach, may be vulnerable to any changes in the environment. For instance, after the ML localization model is trained and deployed in the environment (e.g., within an online phase), one or more APs (or cells) in the network could be switched off, moved, malfunction, or be replaced (e.g., powering off one or more APs for power savings during periods of low network activity, etc.). In such instances, FPs measured by localization users at any RP in the online phase may deviate substantially from the FPs measured in the training or “offline phase” due to the absence of these one or more APs which no longer emit a signal during the online phase, but were available and considered with the training FPs collected in the offline phase. This causes a drift in the mapping LM( ) learned by the model from FPi to {x_(pred_i),y_(pred_i),floor_(pred_i)}, shown in Equation 1. The change in statistics of the underlying ML model data results in distribution shift/concept drift, which can lead to a severe degradation in the indoor localization performance for mobile users.

To improve the viability of machine-learning trained fingerprint-based localization systems, the system may be enhanced with logic to recover/maintain the localization model performance during the occurrence of concept drift. Remediation of such issues may first include the detection of the occurrence of said concept drift (e.g., to determine which specific APs have been switched off, removed, or are not presently operational). Upon identifying the missing APs, the localization model may be retrained to re-learn the mapping LM( ) from modified or updated fingerprints (e.g., with the missing APs removed) to the physical locations—a mapping which reflects the current state of active APs in the environment. Further, such logic may assist in addressing the trade-off between network power savings requirements and indoor localization performance. For instance, if many network APs are switched off with the solitary goal of maximizing power savings, indoor localization performance may be expected to degrade, while maximizing localization performance may result in unrealistic, impractical, or expensive AP up-time requirements, etc.

Other approaches for attempting to remediate concept drift may rely on secondary or additional sensors extraneous to the base wireless infrastructure, such as inertial measurement units (IMUs), pedestrian dead reckoning sensors, accelerometers, gyroscopes, or magnetometers to measure the environment and generate labelled online FPs by relying on sensors that are extraneous to the deployed network infrastructure. Such labelled online FPs may then be compared with the offline FPs using different techniques to detect and measure any drift. Such solutions, however, may fail in instances where such additional sensors are either not available or too expensive for a specific deployment. APs may be modified, in other approaches, with additional hardware and functionality to allow the APs to also act as RPs during the online phase and be the generators of the labelled online FPs, however, such specialized APs may not be available or desired within given deployments. Opportunistic crowdsourcing and/or the use of robots to periodically submit FPs to assist in detecting the occurrence of concept drift, among other approaches, however, these approaches requiring specialized APs or endpoints result in implementations of a fingerprint-based localization, which detract from the very simplicity and hardware-agnostic benefits, which may make fingerprint-based localization an attractive localization solution in the first place, among other example issues.

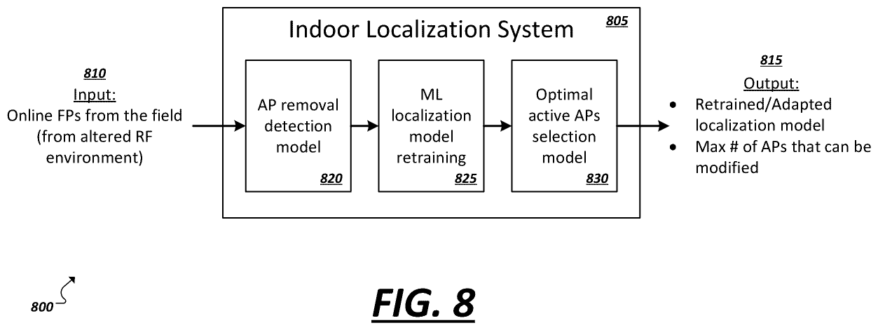

FIG. 8 is a simplified block diagram 800 illustrating an example implementation of an improved RSS fingerprint-based indoor localization system 805, equipped with logic to detect and remediate concept drift resulting from outages in (or otherwise missing) APs within the environment. For instance, blocks of logic may be included in the indoor localization system 805, such as an AP removal detection unit 820, a machine-learning-based localization retraining unit 825, and AP selection unit 830, among other example logic blocks (e.g., which may be implemented in software, firmware, and/or hardware of the indoor localization system 805). In some implementations, the AP removal detection unit 820 may be implemented as (or include) a denoising autoencoder. The AP removal detection unit 820 may utilize a model to predict, from a received input FP (e.g., 810), if a given AP in the environment is missing in the input FP. Additionally, the AP removal detection unit 820 may further predict the Received Signal Strength (RSS) value for that AP in that FP (were the AP present and detected). In the case of the localization retraining module 825, a Multi-Layer Perceptron (MLP) may be utilized as the base machine-learning-based localization model. For the localization model retraining unit 825, a transfer-learning-based approach may be utilized to retrain the underlying localization model (e.g., an MLP-based localization model) to generate an updated, retrained/adapted version of the model (in output 815), among other examples. Further, the AP selection unit 830 may be executed (e.g., by a given processor of the indoor localization system 805) and utilized to determine, from the input FPs (e.g., 810), the maximum number of active APs which can be switched off to maximize power savings while still maintaining the localization performance above a threshold level. This information (e.g., provided in output 815) may be utilized to adjust APs within the environment, such as using an AP orchestrator or management system (e.g., to allow additional APs to be turned off opportunistically to save additional power), among other example implementations.

In some implementations, wireless communication blocks or chips (e.g., integrated within a platform or processor), may be augmented with indoor localization system logic 805. In some implementations, an integrated solution may further include machine-learning acceleration hardware (e.g., a GPU, neural processing unit (NPU), tensor processing unit (TPU), etc.), which may accelerate the execution of instructions used to implement the machine-learning logic of the indoor localization system 805. For instance, the machine-learning-based localization model may be run on the machine learning accelerator hardware, for instance, to train and retrain the localization model (e.g., in real-time) for RF hardware on a corresponding edge device (e.g., with each device inheriting a base localization model and optimizing end-to-end solutions to its RF hardware capabilities). In some implementations, execution of the localization model and/or retraining of the localization model may be handled in a distributed manner (e.g., using a collection of edge device or computing resources associated with the collection of APS), among other examples.

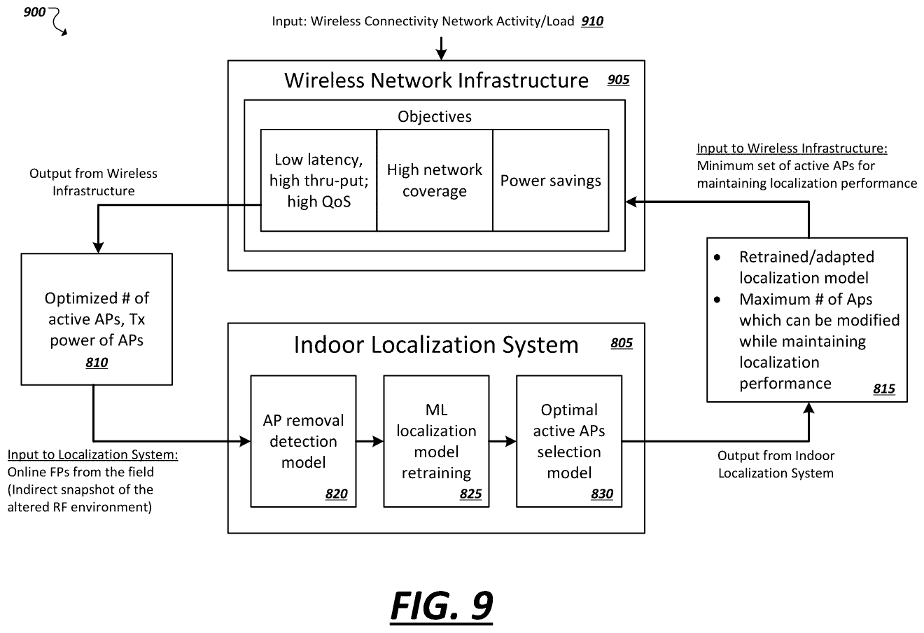

Turning to FIG. 9, a simplified block diagram 900 is shown illustrating an example system, including the wireless network infrastructure of an environment (e.g., including the collection of APs, wireless system management, etc.) and the improved indoor localization system 805. The offline training phase or the localization system 805 may be trained to the specific wireless network infrastructure 805 of the environment (e.g., an office, shopping center, stadium, university, warehouse, manufacturing facility, etc.). When in the online phase (following training of the localization system 805), a feedback loop may be implemented by feeding outputs of the wireless network infrastructure 905 (e.g., as collected by a wireless network management system for the environment) to the indoor localization system 805 as its inputs 810, while the outputs 815 of the indoor localization system 805 are provided as inputs to the wireless network infrastructure 905. For instance, the wireless network infrastructure 905 may monitor performance and activity 910 of its wireless network and attempt to respond to changes in the network activity (e.g., based on the number of active users, the data traffic on the network, etc.), for instance, to improve latency, throughput, and quality of service (QOS) for users while optimizing coverage and power savings of the network. In some implementations, the network management system may attempt to balance the traffic demands on the network (e.g., based on the specific applications using the network, the number of users, etc.) with the amount of power consumed by the system.

The network management system may manage and control the number of active/switched-on APs, vary AP transmit power, among other techniques. Meanwhile, in online mode, the indoor localization system 805 may measure RSS FPs (e.g., on a continuing basis) within the environment. As the network management system makes changes to the APs (e.g., turns some off, reconfigures transmit power, etc.), the FPs collected by the indoor localization system may deviate from what was observed in offline mode (e.g., when all of the APs were on and transmitting in a standard or defined mode). As introduced above, the indoor localization system 805 may include logic (e.g., 820) to detect that certain APs have been removed or otherwise modified within the environment. For instance, as the indoor localization system 805 receives FPs within an altered environment, it collects a snapshot of the changes affected by the wireless network infrastructure 905 and its management system. The AP removal detection unit 820 may use these FPs and detect which APs have been removed by the network. Upon identifying that one or more APs have been removed or otherwise modified, the localization retraining unit 825 may trigger a retraining of the underlying machine-learning-based localization model used by the indoor localization system 805 such that performance of the localization model is recovered to the best extent possible. Further, in some implementations, the indoor localization system 805 may include an AP selection unit 830, which determines which APs removed by the network are highly critical to localization and thereby determine one or more sets of minimum APs which must remain “on” within the environment in order for the localization system 805 to continue to return localization results at a threshold quality level. For instance, the AP selection unit 830 may catalog changes to the localization model over time based on the removal of different APs over time. In some cases, APs may be removed systematically and the localization model performance monitored in response, to determine which APs, when removed from the system, have the most significant impact on the localization performance, among other example techniques. The AP selection unit 830 may identify critical APs or minimum AP sets (or articulated differently, the maximum number of APs which can be modified (or modified in addition to those already modified)) for a localization system and may provide this information an input (e.g., 815) to the wireless network infrastructure 905 in order for the wireless network infrastructure to more intelligently switch off and/or modify in its future power management and optimization activities. Such a closed-loop interaction between network infrastructure 905 and the indoor localization system 805 may help maximize network power savings while maintaining acceptable localization performance, among other example benefits (e.g., determining optimum system maintenance, determining an effective system upgrade strategy, etc.).

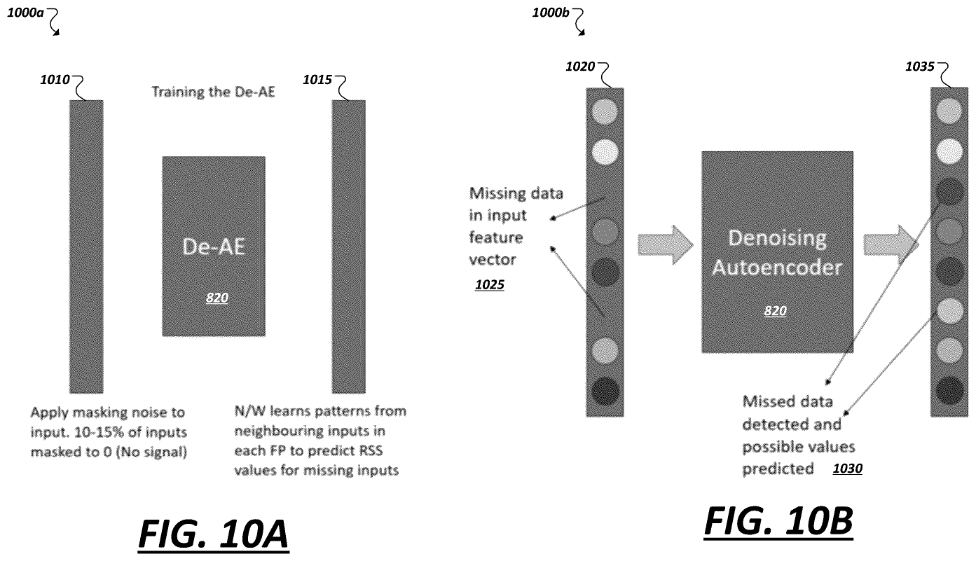

Turning to FIGS. 10A-10B, simplified block diagrams 1000a-b are shown illustrating an example implementation (and training) of an AP removal detection unit 820. In one example implementations, the AP removal detection unit may be implemented as an unsupervised anomaly detection model in cases where the localization model is developed without having labeled FPs for both a class of FPs where all APs are present (e.g., as trained in the offline phase) and a class where one or more APs (from the offline training) is no longer present, malfunctioning, off, or otherwise not detectable. In some implementations, the AP removal detection unit 820 may be implemented as an autoencoder and more particularly as a denoising autoencoder (DAE) to implement a missing input detection solution capable of detecting the missing input(s) of specific missing APs in a given environment. For instance, in order to functionalize the DAE AP removal detection unit to detect missing (e.g., removed or switched off) APs, the DAE may be trained with masking noise 1010 at the input to the DAE, where for each FP presented at the input, a subset of the AP RSS values are randomly changed or masked from a non-zero value to a “No Signal” value at some rate. The DAE thus trained, learns patterns 1015 representing a robust representation of the original data (e.g., from the original offline training). For instance, the DAE learns during its training to not depend heavily on any particular AP's signal in a given FP at any location. For instance, even when one or more APs are missing in a given FP, the DAE learns patterns from the neighboring inputs in the FP to predict which APs are missing in the input FP, as well as infer the RSS values that would have been presented from the missing (e.g., switched off) APs if they were on, at each location. For instance, as shown in FIG. 10B, when trained, the DAE-based AP removal detection unit 820 may be presented with a FP 1020 with RSS values measured from the APs in an environment at a given location in the environment. The FP 1020, however, may have missing RSS values 1025 for one or more of the APs in the environment. In some cases, this may be typical for the environment at a given location (e.g., where signals of a more distant AP or AP blocked by a wall or other obstruction), would not be detected at this location. However, based on the training of the DAE, the AP removal detection unit 820 may instead identify these missing signals at this location to evidence the absence of these one or more APs. Accordingly, the DAE may detect that these one or more APs are missing. Further, based on the training of the DAE, the AP removal detection unit 820 may also predict or infer what RSS signal values these missing APs would have exhibited had they be present in the environment (at 1030) by generating an encoded version 1035 of the FP 1020 to include the values for the missing AP signals. In some implementations, the DAE may predict a value other than “no signal” for a given AP in the FP. However, the predicted signal strength may be so low as to effectively suggest that the associated AP is not present. Accordingly, in some implementations, for predicted RSS below a threshold RSS, a corresponding AP may be determined to be (or indicated to be) missing (e.g., with the RSS rounded down to a zero value), among other examples features.

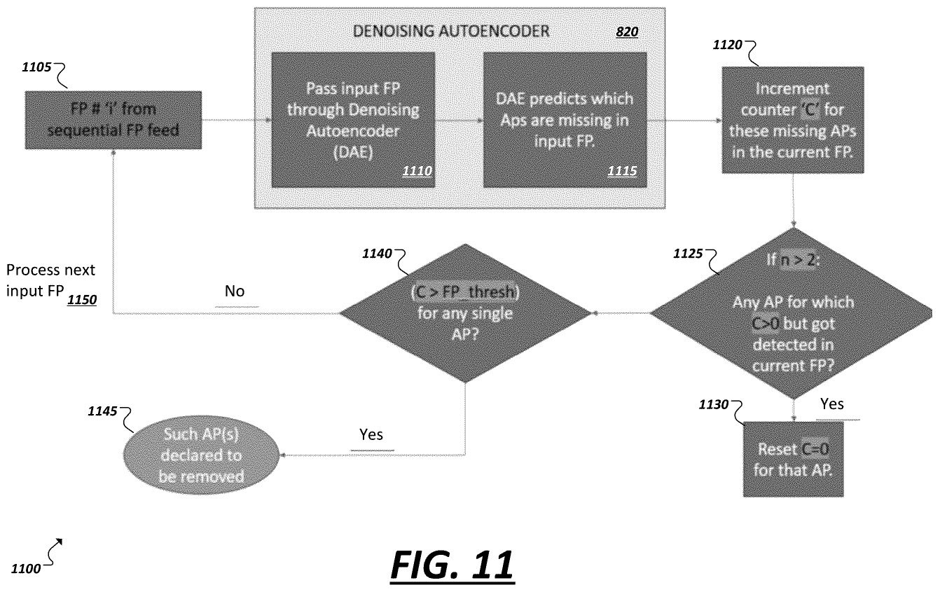

Turning to FIG. 11, a simplified flow diagram 1100 is shown illustrating example operation of an example DAE-based AP removal detection unit 820. For instance, when in online mode, FPs may be received 1105 at the localization system from various user endpoint devices positioned within an environment in which a number of APs are provided (e.g., to provide wireless networking infrastructure, as well as for use in the indoor localization service). The FPS may be included in localization requests and include a vector of the RSS detected by the requesting user endpoint from the collection of APs in the environment. The AP removal detection unit 820 of the localization system may be used to detect that one or more of the APs (e.g., present during the training of the localization system) is now missing. For instance, each received FP may be passed through a denoising encoder (at 1110) of the localization system and the denoising encoder may determine (at 1115), which APs (from the original set) are missing (e.g., based on the RSS values included in the input FP). In some implementations, any time the AP removal detection unit 820 identifies a missing or otherwise low-signal AP from a received FP, the AP removal detection unit 820 may determine the AP to be missing and trigger a retraining of the indoor localization model. In other instances (such as shown in the example of FIG. 11), the AP removal detection unit 820 may only signal that a given AP is missing (and trigger localization model retraining) when the given AP has been detected as missing in a threshold number (e.g., 1 or more) of FPs (e.g., missing in “FP_thresh” consecutive FPs). For instance, upon detecting missing APs from a last-received FP, the AP removal detection unit 820 may increment (at 1120) a counter “C” for each of the missing APs. The AP removal detection unit 820 may also check (e.g., at 1125) whether any of the environment's APs, which in immediately preceding FPS had been detected as missing, was detected in the present FP. If so, the counter for the “reappearing” AP is decremented to zero (at 1130). Following the incrementing of counters (at 1120) for APs detected to be missing in the current FP, the AP removal detection unit 820 may check (at 1140) if the incrementing of the counter(s) resulting in any of the missing APs' counter values exceeding a threshold value (e.g., FP_thresh). The threshold value may be a system-wide threshold or, alternatively, an AP-specific threshold. The threshold may also have a time element or subject to weighted counting, such that the counter resets or decrements after a period of time (e.g., to protect against unnecessary retraining of the localization model based on a false-positive detection of a missing AP), among other example features. If the threshold is exceeded for an AP, the AP removal detection unit 820 may declare the AP as missing (at 1145) and trigger a retraining of the localization model to account for the missing AP(s). The AP removal detection unit 820 may continue receiving (at 1150) to continuously detect the new removal or outage of other APs in the system, as well as the reemergence of a previously missing AP in the system (e.g., at which point, the AP removal detection unit 820 may trigger a reversion back to a preceding trained version of the localization model or trigger another retraining of the localization model (e.g., in case the signal strength or location of the remerging AP have changed since the original training of the model), among other example implementations.

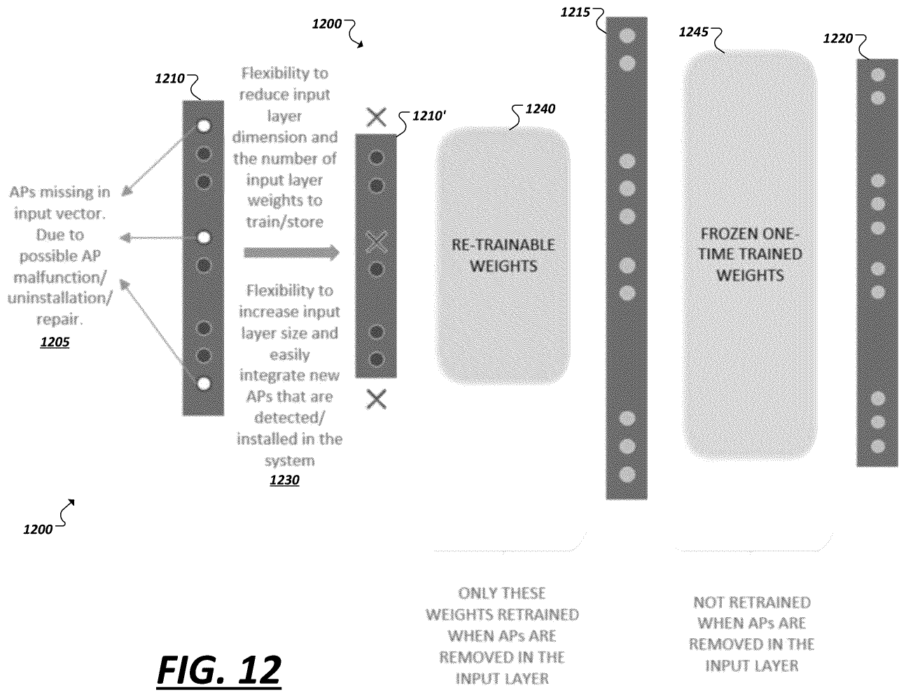

Turning to FIG. 12, a simplified block diagram 1200 is shown of the example retraining of a localization model responsive to and to account for the detection of one or more APs determined to be missing within an environment by an AP removal detection unit of the indoor localization system. In the example of FIG. 12, an indoor localization model may be implemented as a neural network model 1205, such as a feedforward neural network 1205 including an input layer 1210 and a set of hidden layers (e.g., 1215, 1220, etc.), and an output layers. Other implementations may utilize other neural networks to implement the indoor localization models, such as convolutional neural networks, recurrent neural networks, among others, and a localization retraining unit 825 may apply similar principles to retrain such other neural network-based indoor localization models. The localization retraining unit 825 may be triggered by the AP removal detection unit identifying that one or more APs in an environment may be missing 1225 and the localization retraining unit 825 may reduce 1230 the input layer dimension to generate a reduced input layer 1210′ for the localization model. A subset of the weights 1240 in the neural network model may be retrained 1235 based on the APs removed from the input layer 1210′, whereas another subset of the weights 1245 are “frozen” and not retrained during the retraining of the indoor localization model based on the missing APs (e.g., based on principles of transfer learning). In some implementations, retraining of the model based on missing APs may reuse the training set used in the original, “offline” training of the model (e.g., through retrieving the training set of FPs from a database associated with the indoor localization system) and removing the missing AP's (or APs′) vector position(s) from the respective fingerprints in the original training data (e.g., corresponding to the environment). Accordingly, when an AP is determined to be missing (e.g., switched off, malfunctioning, etc.), only the size of the input layer 1210 is changed, where the sizes of the hidden layers and output layer remain the same (as in the original model trained for the environment during offline training). As a result, training weights between the input and the first hidden layers [(P−n)×(Q) weights] is sufficient to recover localization performance (where ‘n’=Number of APs removed, P=Input Layer size, Q=Hidden layer 1 size). The localization retraining unit 825 may perform a form of Transfer Learning (TL) to retrain the localization model, where the remaining weights are “transferred” or “carried forward” to the retrained model instead of retraining them. The retrained model may be tested to ensure its accuracy, allowing the retrained model to be deployed and used in lieu of the original model. In some cases, while retraining and validation of the retrained model are being completed, the original model may continue to be used (e.g., albeit with potentially attenuated results), among other example implementations and features.

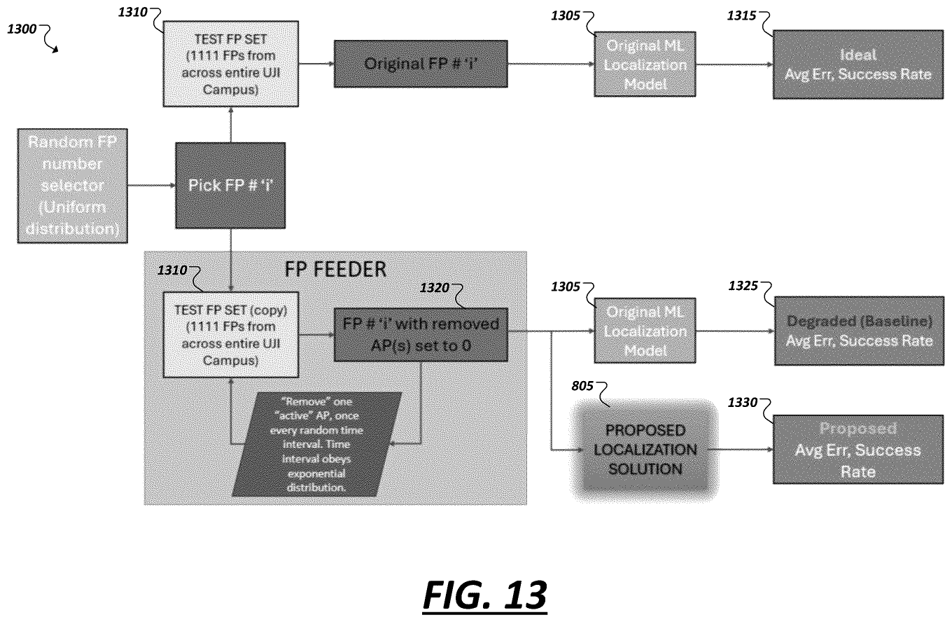

FIG. 13 is a simplified block diagram illustrating an example setup for performing a comparative test of an improved indoor localization system 805 against a fixed version 1305 of the indoor localization system's localization model (as configured through the original offline training of the model). When presented with a set of test FPs 1310 that reflect an environment without any missing APs, the original localization model 1305 generates accurate localization inferences 1315. To test performance in the case of missing APs, the test FP data may be augmented 1320, for instance, by randomly removing some of the APs from the fingerprints (e.g., by setting their RSS values to zero) and these altered test FPs may be provided both to the original localization model 1305 and the localization system 805 enhanced to detect missing APs and dynamically retrain the model accordingly. The results 1325 of the original localization model 1305 will be expected to be degraded, while the adaptive localization system 805 is able to maintain threshold level accuracy (at 1330), despite the changes to the set of APs. In one example of a simulated test, APs may be switched off one by one (e.g., as a Poisson process over time) while a sequential “feed” of FPs is processed by our solution. In one example, 40% of the active APs in an environment (e.g., a university campus) are switched off over a first two-hour window, with the improved localization system 805 adapting performance to the missing APs by retraining the localization model whenever an AP switch off is detected. This approach may yield results showing significant improvement over simply relying on the original localization model 1305. For instance, in time-dynamic scenarios, the improved localization system is able to significantly recover localization performance in the online phase when on-field APs are switched off. This holds great promise in improving robustness of indoor localization models to environment dynamics. Further, by also identifying the APs most critical for localization, the localization system can help optimize the trade-off of power savings and localization performance in an example environment.

“Logic”, as used herein, may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software-based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 418A0 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, e.g., reset, while an updated value potentially includes a low logical value, e.g., set. Note that any combination of values may be utilized to represent any number of states.

The embodiments of methods, hardware, software, firmware, or code set forth above may be implemented via instructions or code stored on a machine-accessible, machine readable, computer accessible, or computer readable medium which are executable by a processing element. A non-transitory machine-accessible/readable medium includes any mechanism that provides (e.g., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is a non-transitory machine-readable storage medium with instructions stored thereon, the instructions executable by a machine to cause the machine to: receive a fingerprint from a device, where the fingerprint identifies a plurality of signal strength values corresponding to a plurality of wireless access points as measured by the device within a physical environment; determine from a first model that a subset of access points in the plurality of wireless access points is missing in the physical environment based on the fingerprint; and modify a machine-learning-based localization model to generate a modified localization model to account for the subset of access points missing in the physical environment, where the localization model is trained based on training data collected when the plurality of wireless access points were present and operational within the environment.

Example 2 includes the subject matter of example 1, where the fingerprint is included on a localization request, and the localization request requests identification of coordinates of the device within the physical environment based on the machine-learning-based localization model.

Example 3 includes the subject matter of example 2, where the localization request is one of a plurality of localization requests and the first model is used to determine that the subset of access points are missing in each of the plurality of localization requests, and the instructions are further executable to cause the machine to: determine a change in the plurality of wireless access points in the physical environment based on the missing subset of access points in the plurality of localization requests; and trigger a modification of the machine-learning-based localization model based on the change in the plurality of wireless access points in the physical environment.

Example 4 includes the subject matter of example 3, where the change is determined based on a determination that the subset of access points are missing from a threshold number of consecutive localization requests.

Example 5 includes the subject matter of any one of examples 1-4, where the localization model includes a neural network, and the localization model is modified to decrease size of an input layer of the neural network and retrain at least a portion of weights of the neural network.

Example 6 includes the subject matter of example 5, where the weights in the neural network includes the portion and another portion of the weights of the neural network, where only the portion are retrained to modify the localization model.

Example 7 includes the subject matter of any one of examples 5-6, where the training data includes a plurality of training fingerprints for a plurality of known coordinates within the physical environment, each training fingerprint in the plurality of training fingerprints includes a respective signal strength value for each of the plurality of wireless access points as measured at a corresponding one of the plurality of known coordinates, and the instructions are further executable to cause the machine to: change values in the plurality of training fingerprints to remove values for the subset of access points to generate revised training data, where the revised training data is to be used to retrain the portion of the weights.

Example 8 includes the subject matter of any one of examples 1-7, where the instructions are further executable to cause the machine to: receive a given localization request from a given device in the physical environment; and use the modified localization model to determine coordinates of the given device within the physical environment.

Example 9 includes the subject matter of any one of examples 1-8, where the localization model includes a feedforward neural network.

Example 10 includes the subject matter of any one of examples 1-9, where the first model includes a denoising autoencoder.

Example 11 includes the subject matter of example 10, where the denoising autoencoder is trained based on a modified version of the training data, where the training data is modified with masking noise to generate the modified version of the training data.

Example 12 includes the subject matter of any one of examples 1-11, where the localization model is trained to perform indoor localization within the physical environment.

Example 13 includes the subject matter of any one of examples 1-12, where the plurality of wireless access points includes Wi-Fi access points or Bluetooth access points.

Example 14 includes the subject matter of any one of examples 1-13, where the instructions are further executable to cause the machine to identify a minimum subset of access points in the plurality of wireless access points to maintain a threshold accuracy level of location prediction using the localization model.

Example 15 includes the subject matter of any one of examples 1-14, where the modified localization model is trained without additional location sensor inputs.

Example 16 includes the subject matter of any one of examples 1-15, where the modified localization model is trained without supplemental training data not based on the training data.

Example 17 is a method including: receiving a localization request from a device within a physical environment, where the localization request includes a fingerprint identifying a plurality of signal strength values corresponding to a plurality of wireless access points as measured by the device within the physical environment; determining from a machine-learning-based missing access point detection model that a subset of access points in the plurality of wireless access points is missing in the physical environment based on the fingerprint; and modifying a machine-learning-based localization model to generate a modified localization model based on determining that the subset of access points are missing in the physical environment, where the localization model is trained based on training data collected when the plurality of wireless access points were present and operational within the physical environment.

Example 18 includes the subject matter of example 17, further including: receiving a subsequent localization request from a given device following modification of the localization model, where the subsequent localization request includes a respective fingerprint; and determining, using the modified localization model, coordinates of the given device within the physical environment based on the respective fingerprint included in the subsequent localization request.

Example 19 includes the subject matter of any one of examples 17-18, further including determining a minimum number of active wireless access points to maintain in the plurality of wireless access points to preserve an accuracy level for localizations determined using the localization model.

Example 20 includes the subject matter of any one of examples 17-19, where the localization request is one of a plurality of localization requests and the missing access point detection model is used to determine that the subset of access points are missing in each of the plurality of localization requests, and the method further includes: determining a change in the plurality of wireless access points in the physical environment based on the missing subset of access points in the plurality of localization requests; and triggering a modification of the machine-learning-based localization model based on the change in the plurality of wireless access points in the physical environment.

Example 21 includes the subject matter of example 20, where the change is determined based on a determination that the subset of access points are missing from a threshold number of consecutive localization requests.

Example 22 includes the subject matter of any one of examples 17-21, where the localization model includes a neural network, and the localization model is modified to decrease size of an input layer of the neural network and retrain at least a portion of weights of the neural network.

Example 23 includes the subject matter of example 22, where the weights in the neural network includes the portion and another portion of the weights of the neural network, where only the portion are retrained to modify the localization model.

Example 24 includes the subject matter of any one of examples 22-23, where the training data includes a plurality of training fingerprints for a plurality of known coordinates within the physical environment, each training fingerprint in the plurality of training fingerprints includes a respective signal strength value for each of the plurality of wireless access points as measured at a corresponding one of the plurality of known coordinates, and the method further includes: changing values in the plurality of training fingerprints to remove values for the subset of access points to generate revised training data, where the revised training data is to be used to retrain the portion of the weights.

Example 25 includes the subject matter of any one of examples 17-24, further including: receiving a given localization request from a given device in the physical environment; and using the modified localization model to determine coordinates of the given device within the physical environment.

Example 26 includes the subject matter of any one of examples 17-25, where the localization model includes a feedforward neural network.

Example 27 includes the subject matter of any one of examples 17-26, where the first model includes a denoising autoencoder.

Example 28 includes the subject matter of example 27, where the denoising autoencoder is trained based on a modified version of the training data, where the training data is modified with masking noise to generate the modified version of the training data.

Example 29 includes the subject matter of any one of examples 17-28, where the localization model is trained to perform indoor localization within the physical environment.

Example 30 includes the subject matter of any one of examples 17-29, where the plurality of wireless access points includes Wi-Fi access points or Bluetooth access points.

Example 31 includes the subject matter of any one of examples 17-30, where the instructions are further executable to cause the machine to identify a minimum subset of access points in the plurality of wireless access points to maintain a threshold accuracy level of location prediction using the localization model.

Example 32 includes the subject matter of any one of examples 17-31, where the modified localization model is trained without additional location sensor inputs.

Example 33 includes the subject matter of any one of examples 17-32, where the modified localization model is trained without supplemental training data not based on the training data.

Example 34 is a system including means to perform the method of any one of examples 17-33.

Example 35 is a system including: at least one processor; a memory; and an indoor localization system, executable by the at least one processor to: receive a fingerprint from a device, where the fingerprint identifies a plurality of signal strength values corresponding to a plurality of wireless access points as measured by the device within a physical environment; determine from a first model that a subset of access points in the plurality of wireless access points is missing in the physical environment based on the fingerprint; and modify a machine-learning-based localization model to generate a modified localization model to account for the subset of access points missing in the physical environment, where the localization model is trained based on training data collected when the plurality of wireless access points were present and operational within the environment.

Example 36 includes the subject matter of example 35, further including a set of edge computing devices including respective processors, and the one or more processors include at least one of the processors of the set of edge computing devices.

Example 37 includes the subject matter of any one of examples 35-36, further including a management system executable by the one or more processors to: manage the plurality of wireless access points to maintain a level of wireless access within the physical environment; and receive an indication from the indoor localization system of a number of wireless access points to maintain in order to preserve performance of an indoor localization service provided through the indoor localization system.

Example 38 includes the subject matter of example 37, where the management system is further to turn off power to a select subset of the plurality of wireless access points based on the indication.

Example 39 includes the subject matter of any one of examples 35-38, where the fingerprint is included on a localization request, and the localization request requests identification of coordinates of the device within the physical environment based on the machine-learning-based localization model.

Example 40 includes the subject matter of example 39, where the localization request is one of a plurality of localization requests and the first model is used to determine that the subset of access points are missing in each of the plurality of localization requests, and the indoor localization system is further executable to: determine a change in the plurality of wireless access points in the physical environment based on the missing subset of access points in the plurality of localization requests; and trigger a modification of the machine-learning-based localization model based on the change in the plurality of wireless access points in the physical environment.

Example 41 includes the subject matter of example 40, where the change is determined based on a determination that the subset of access points are missing from a threshold number of consecutive localization requests.

Example 42 includes the subject matter of any one of examples 35-41, where the localization model includes a neural network, and the localization model is modified to decrease size of an input layer of the neural network and retrain at least a portion of weights of the neural network.

Example 43 includes the subject matter of example 42, where the weights in the neural network includes the portion and another portion of the weights of the neural network, where only the portion are retrained to modify the localization model.

Example 44 includes the subject matter of any one of examples 42-43, where the training data includes a plurality of training fingerprints for a plurality of known coordinates within the physical environment, each training fingerprint in the plurality of training fingerprints includes a respective signal strength value for each of the plurality of wireless access points as measured at a corresponding one of the plurality of known coordinates, and the indoor localization system is further executable to: change values in the plurality of training fingerprints to remove values for the subset of access points to generate revised training data, where the revised training data is to be used to retrain the portion of the weights.

Example 45 includes the subject matter of any one of examples 35-44, where the indoor localization system is further executable to: receive a given localization request from a given device in the physical environment; and use the modified localization model to determine coordinates of the given device within the physical environment.

Example 46 includes the subject matter of any one of examples 35-45, where the localization model includes a feedforward neural network.

Example 47 includes the subject matter of any one of examples 35-46, where the first model includes a denoising autoencoder.

Example 48 includes the subject matter of example 47, where the denoising autoencoder is trained based on a modified version of the training data, where the training data is modified with masking noise to generate the modified version of the training data.

Example 49 includes the subject matter of any one of examples 35-48, where the localization model is trained to perform indoor localization within the physical environment.

Example 50 includes the subject matter of any one of examples 35-49, where the plurality of wireless access points includes Wi-Fi access points or Bluetooth access points.

Example 51 includes the subject matter of any one of examples 35-50, where the instructions are further executable to cause the machine to identify a minimum subset of access points in the plurality of wireless access points to maintain a threshold accuracy level of location prediction using the localization model.

Example 52 includes the subject matter of any one of examples 35-51, where the modified localization model is trained without additional location sensor inputs.

Example 53 includes the subject matter of any one of examples 35-52, where the modified localization model is trained without supplemental training data not based on the training data.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplary language does not necessarily refer to the same embodiment or the same example, but may refer to different and distinct embodiments, as well as potentially the same embodiment.

What is claimed is:

1. At least one non-transitory machine-readable storage medium with instructions stored thereon, the instructions executable by a machine to cause the machine to:
receive a fingerprint from a device, wherein the fingerprint identifies a plurality of signal strength values corresponding to a plurality of wireless access points as measured by the device within a physical environment;
determine from a first model that a subset of access points in the plurality of wireless access points is missing in the physical environment based on the fingerprint; and
modify a machine-learning-based localization model to generate a modified localization model to account for the subset of access points missing in the physical environment, wherein the localization model is trained based on training data collected when the plurality of wireless access points were present and operational within the environment.

2. The at least one storage medium of claim 1, wherein the fingerprint is included on a localization request, and the localization request requests identification of coordinates of the device within the physical environment based on the machine-learning-based localization model.

3. The at least one storage medium of claim 2, wherein the localization request is one of a plurality of localization requests and the first model is used to determine that the subset of access points is missing in each of the plurality of localization requests, and the instructions are further executable to cause the machine to:
determine a change in the plurality of wireless access points in the physical environment based on the missing subset of access points in the plurality of localization requests; and
trigger a modification of the machine-learning-based localization model based on the change in the plurality of wireless access points in the physical environment.

4. The at least one storage medium of claim 3, wherein the change is determined based on a determination that the subset of access points is missing from a threshold number of consecutive localization requests.

5. The at least one storage medium of claim 1, wherein the localization model comprises a neural network, and the localization model is modified to decrease size of an input layer of the neural network and retrain at least a portion of weights of the neural network.

6. The at least one storage medium of claim 5, wherein the weights in the neural network comprises the portion and another portion of the weights of the neural network, wherein only the portion is retrained to modify the localization model.

7. The at least one storage medium of claim 5, wherein the training data comprises a plurality of training fingerprints for a plurality of known locations within the physical environment, each training fingerprint in the plurality of training fingerprints comprises a respective signal strength value for each of the plurality of wireless access points as measured at a corresponding one of the plurality of known locations, and the instructions are further executable to cause the machine to:
change the plurality of training fingerprints to remove values for the subset of access points from the plurality of training fingerprints to generate revised training data, wherein the revised training data is to be used to retrain the portion of the weights.

8. The at least one storage medium of claim 1, wherein the instructions are further executable to cause the machine to:
receive a given localization request from a given device in the physical environment; and
use the modified localization model to determine coordinates of the given device within the physical environment.

9. The at least one storage medium of claim 1, wherein the localization model comprises a feedforward neural network.

10. The at least one storage medium of claim 1, wherein the first model comprises a denoising autoencoder.

11. The at least one storage medium of claim 10, wherein the denoising autoencoder is trained based on a modified version of the training data, wherein the training data is modified with masking noise to generate the modified version of the training data.

12. The at least one storage medium of claim 1, wherein the localization model is trained to perform indoor localization within the physical environment.

13. The at least one storage medium of claim 1, wherein the plurality of wireless access points comprises Wi-Fi access points or Bluetooth access points.

14. The at least one storage medium of claim 1, wherein the instructions are further executable to cause the machine to identify a minimum subset of access points in the plurality of wireless access points to maintain a threshold accuracy level of location prediction using the localization model.

15. A method comprising:
receiving a localization request from a device within a physical environment, wherein the localization request comprises a fingerprint identifying a plurality of signal strength values corresponding to a plurality of wireless access points as measured by the device within the physical environment;
determining from a machine-learning-based missing access point detection model that one or more access points in the plurality of wireless access points are missing in the physical environment based on the fingerprint; and
modifying a machine-learning-based localization model to generate a modified localization model based on determining that the one or more access points are missing in the physical environment, wherein the localization model is trained based on training data collected when the plurality of wireless access points were all present and operational within the physical environment.

16. The method of claim 15, further comprising:
receiving a subsequent localization request from a given device following modification of the localization model, wherein the subsequent localization request comprises a respective fingerprint;
determining, using the modified localization model, coordinates of the given device within the physical environment based on the respective fingerprint included in the subsequent localization request.

17. The method of claim 15, further comprising determining a minimum number of active wireless access points to maintain in the plurality of wireless access points to preserve an accuracy level for localizations determined using the localization model.

18. A system comprising:
at least one processor;
a memory;
instructions executable by the at least one processor to:
receive a fingerprint from a device, wherein the fingerprint identifies a plurality of signal strength values corresponding to a plurality of wireless access points as measured by the device within a physical environment;
determine from a first model that a subset of access points in the plurality of wireless access points is missing in the physical environment based on the fingerprint; and
modify a machine-learning-based localization model to generate a modified localization model to account for the subset of access points missing in the physical environment, wherein the localization model is trained based on training data collected when the plurality of wireless access points were present and operational within the environment.

19. The system of claim 18, further comprising a set of edge computing devices comprising respective processors, and the one or more processors comprise at least one of the processors of the set of edge computing devices.

20. The system of claim 18, further comprising instructions executable by the one or more processors to:
manage the plurality of wireless access points to maintain a level of wireless access within the physical environment;
receive an indication from the indoor localization system of a number of wireless access points to maintain in order to preserve performance of an indoor localization service provided through the indoor localization system; and
reduce power to a select subset of the plurality of wireless access points based on the indication.
